(19) United States
(12) Patent Application Publication
(10) Pub. No.: US 2016/0199714 A1
(43) Pub. Date: Jul. 14, 2016

(54) Golf Game

(71) Applicant: Peter Constantino, Skaneateles, NY (US)

(72) Inventor: Peter Constantino, Skaneateles, NY (US)

(21) Appl. No.: 14/596,560

(22) Filed: Jan. 14, 2015

(51) Int. Cl. A63B 67/02; A63B 69/36; A63B 57/00; A63B 71/06; A63B 47/02

(52) U.S. Cl. CPC A63B 67/02; A63B 71/0669; A63B 47/021; A63B 57/0081; A63B 69/3694; A63B 2220/806; A63B 2225/20; A63B 2071/0691

(57) ABSTRACT

A golf game includes a centrally located playing structure from which players may hit golf balls towards any number of greens that are spaced at various distances from the playing structure and are within a “fairway”. Once the golfers all hit their golf balls toward this first green, the playing structure rotates on a turntable to position the golfers (standing at their tee box area) towards a second fairway where each can then hit another golf ball(s) towards any number of greens located in this second fairway. This process continues until each golfer has played as many holes as desired (e.g., 18 holes for a regulation game of golf).

### REFERENCE TO RELATED APPLICATION

N/A

### BACKGROUND

1. Field of Invention

The present invention relates generally to the game of golf, and more particularly to a golf game in which players hit from a movable playing structure to a series of greens.

2. Background of Art

The 2011 Golf Economy Report represents the third study estimating the economic impact of the golf industry in the United States (2000, 2005, 2011). Over the past decade, the golf industry has endured two significant U.S. economic recessions. In spite of the challenging economic conditions, the game of golf continues to offer lifelong recreational opportunities and enjoyment for millions of people in the U.S. and around the world.

While golf revenue has contracted between 2005 and 2011 it remains higher than in 2000, with inflation having increased approximately 13.4% over this same period. Relative strengths of golf were found in core golf operations, tournaments and associations, and golf related travel. However, the declining revenue is attributable at least in part to golf real estate (down 68.3 percent between 2005 and 2011) and golf course capital investment (down 42.1 percent over that time period), including new golf course construction. Nevertheless, core golf operations remained strong. However, with less leisure time, less money to spend on recreational activities in light of the challenging economic environment, and fewer golf course operations available, alternatives to traditional golf are needed.

3. Advantages

It is therefore an advantage of the present invention to provide a competitive, socially engaging, swing improving, reasonably timed, affordable, family oriented, conveniently offered, controlled environment in which to play golf.

Other advantages of the present invention will appear hereinafter and others will be apparent.

### SUMMARY OF THE INVENTION

The present invention comprises a golf game. More specifically, an embodiment of the golf game comprises a centrally located playing structure from which players may simultaneously hit golf balls towards any number of greens that are spaced at various distances from the playing structure and are within a target green area (or fairway). Once the golfers all hit their golf balls towards the green(s) in this “fairway” area, the playing structure rotates on a turntable to position the golfers (standing within their tee box area) towards a second fairway where each can then hit another golf ball(s) towards any number of greens located in this second fairway. This process continues until each golfer has played as many holes as desired (e.g., 18 holes for a regulation game of golf). Typically 4 players in each tee box, with 9 tee boxes around the perimeter on each floor of the playing structure. The rotation of the playing structure is typically timed in 5-minute intervals.

In a first aspect, the golf game comprises a playing structure comprising a plurality of tee areas; a plurality of fairways positioned circumferentially around the playing structure; and a plurality of greens positioned within each of the plurality of fairways, each of the plurality of greens in any given one of the fairways being spaced at different distance from the playing structure than all other greens in the same fairway.

In a second aspect, a method for playing a golf game from a playing structure that is mounted on a rotatable turntable, comprises the steps of hitting a golf ball from a tee box area towards a first green in a first fairway; indexing the playing structure such that the tee box area faces a second target green area; and hitting a golf ball from the tee box area towards a second green in a second fairway.

### BRIEF DESCRIPTION OF THE DRAWINGS

The present invention will be more fully understood and appreciated by reading the following Detailed Description in conjunction with the accompanying drawings, in which:

FIG. 1 is a plan view of golf game in accordance with an embodiment of the present invention;

FIG. 2 is a front elevation view of a playing structure carousel in accordance with an embodiment of the present invention;

FIG. 3 is a cross-sectional view taken along section line 3-3 of FIG. 2;

FIG. 4 is a plan view of golf game in accordance with a second embodiment of the present invention;

FIG. 5 is a front elevation view of the playing structure in accordance with the second embodiment of the present invention; and

FIG. 6 is a cross-sectional view taken along section line 6-6 of FIG. 5.

### DETAILED DESCRIPTION

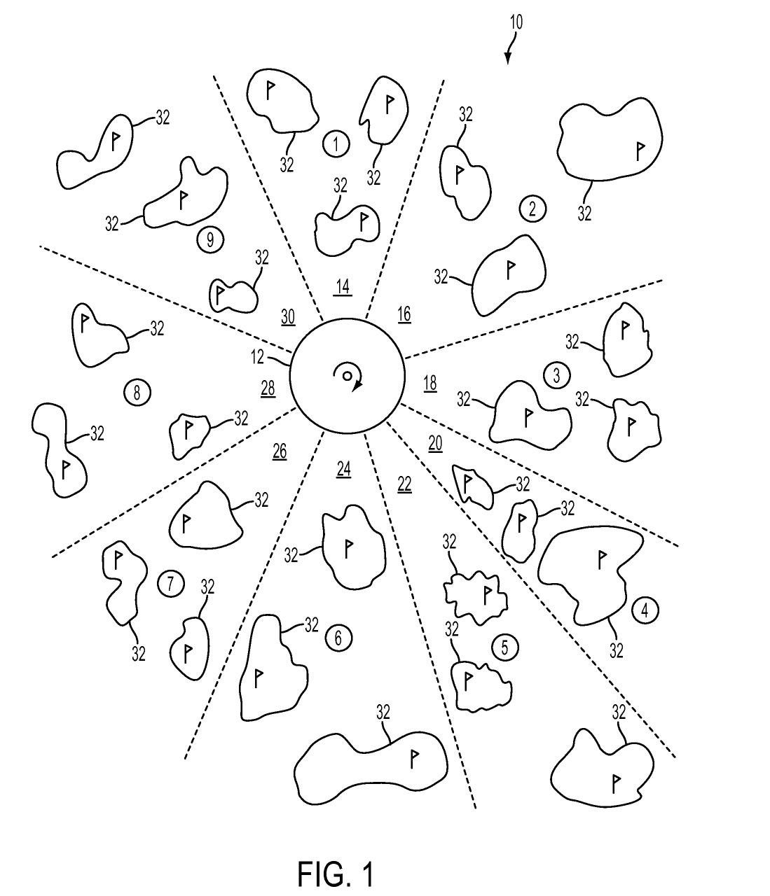

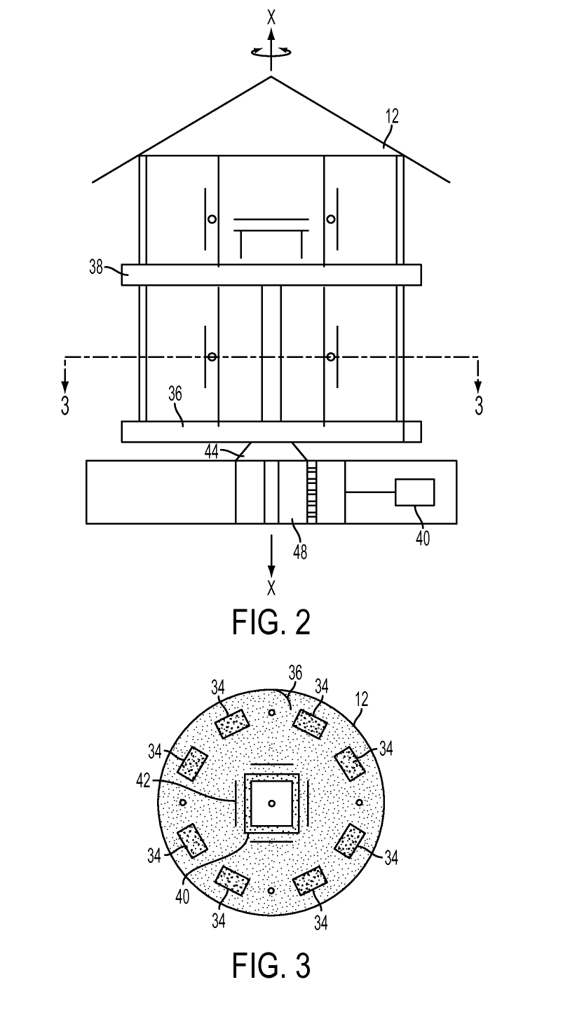

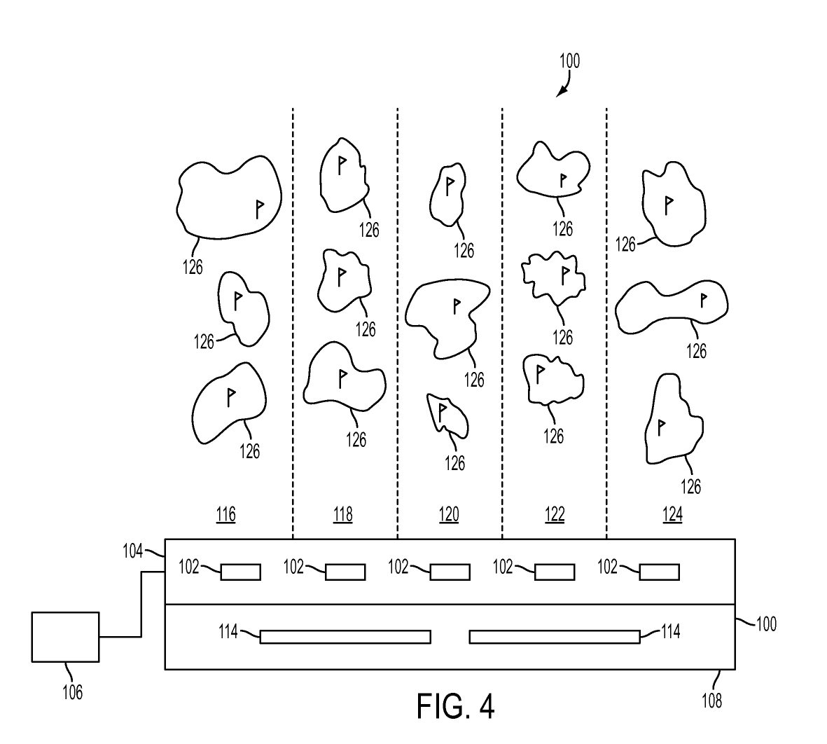

In reference to the drawings, wherein like reference numerals refer to like parts throughout, there is seen in FIG. 1 a golf game designated generally by reference numeral 10. Golf game 10 generally comprises a carousel playing structure 12, and a series of green target areas or “fairways” 14, 16, 18, 20, 22, 24, 26, 28, and 30, positioned circumferentially around playing structure 12 and each of which contains (in the illustrated embodiment) three greens 32 at various distances from the playing structure 12. While in the preferred embodiment, each fairway 14-30 includes three greens 32, it should be understood that any number of greens is feasible depending on space constraints. In its preferred form, the playing structure 12 is shaped in the form of a carousel that rotates clockwise about its central axis X-X (see FIG. 2). After a golfer shoots at a particular green 32 in a fairway (e.g., green area 14), the carousel tee box 12 is actuated to index a certain number of degrees such that the golfer is now facing the next green (e.g., green area 16) area while not having to move from his/her designated tee box area 34 (see FIG. 3). While the playing structure 12 is in the preferred embodiment illustrated and described as a carousel, as will be more fully described hereinafter, other types and shapes of playing structures that permit golfers to shoot at the various fairways and greens without having to walk to a new tee box is possible. For example, playing structure 12 could embody a linear shape that is movable along its longitudinal axis to position golfers standing at a tee box area 34 towards adjacently positioned fairways, as shown in FIG. 4.

With reference to FIGS. 2 and 3, carousel playing structure 12 comprises in its preferred form, two tiers 36, 38 of tee box areas 34. Each tier 36, 38 includes several (9 in the embodiment illustrated in FIG. 3) tee box areas 34 from which a series of golfers (e.g., four golfers) may tee off. The playing structure 12 further comprises an elevator and/or stair well 40 positioned at its center, and a series of food and beverage stations 42 from which the golfers may be served by staff members. A roof 43 is provided in covering relation to upper tier 38 to provide the golfers with protection from the weather, such that golf game 10 may be played in rain or other inclement weather. Other amenities, such as television sets and monitors on which live scoring may be viewed (not shown) may also be included within carousel playing structure 12.

Carousel playing structure 12 is mounted upon a rotating turntable 44 that is driven by a motor 46 and gear arrangement 48. Upon actuation of motor 46, the carousel playing structure 12 will rotate clock-wise a predetermined number of degrees such that each golfer tee box area 34 will face the next set of fairways and greens 32. Rotation of carousel playing structure 12 may be programmed to occur at predetermined timed intervals or upon manual actuation.

Golf game 10 is played using PGA USDA sanctioned golf clubs and balls on a course preferably encompassing between 16 and 20 acres. Each hole length will preferably vary anywhere between 70 yards and 200 yards. Each green 32 is regulated in size and quality taking into account appropriate turf technology for a specific geographic area.

In its preferred form each tee area 34 will permit up to four golfers and in the embodiment shown in FIG. 1, up to 9 tee areas 34, so 36 total golfers. This number can of course vary by increasing or decreasing the number of tee box areas and/or the number of golfers at the appropriate tee box area. Each player in each tee box area 34 would simultaneously hit up to five shots at each green 32 within their current fairway 14-30. The tee box areas 34 are large enough to accommodate safe swing distances (e.g., 12-15 in diameter linear feet per golfer to execute shots). Regulation balls are color coded or otherwise identified for individual player identification. Score keeping is determined by player controlled pre-selected scoring games, most of which reflect traditional acceptable golf score-keeping and are automatically computer tallied, reported and accumulated prior to the next hole, discussed in detail below.

Upon completion of a hole, turntable 44 rotates clock-wise until the tee box area 34 are facing the next fairway. Each group of golfers then hits up to five shots, with the scoring working in the same manner previously described and the turntable then incrementing to the next hole. In a preferred form, each player is allowed a maximum of five minutes in which to complete the five shots at which time the turntable 44 will automatically index to the next fairway. If 18 holes are played, this would permit an entire 18 hole round to be played in 90 minutes maximum.

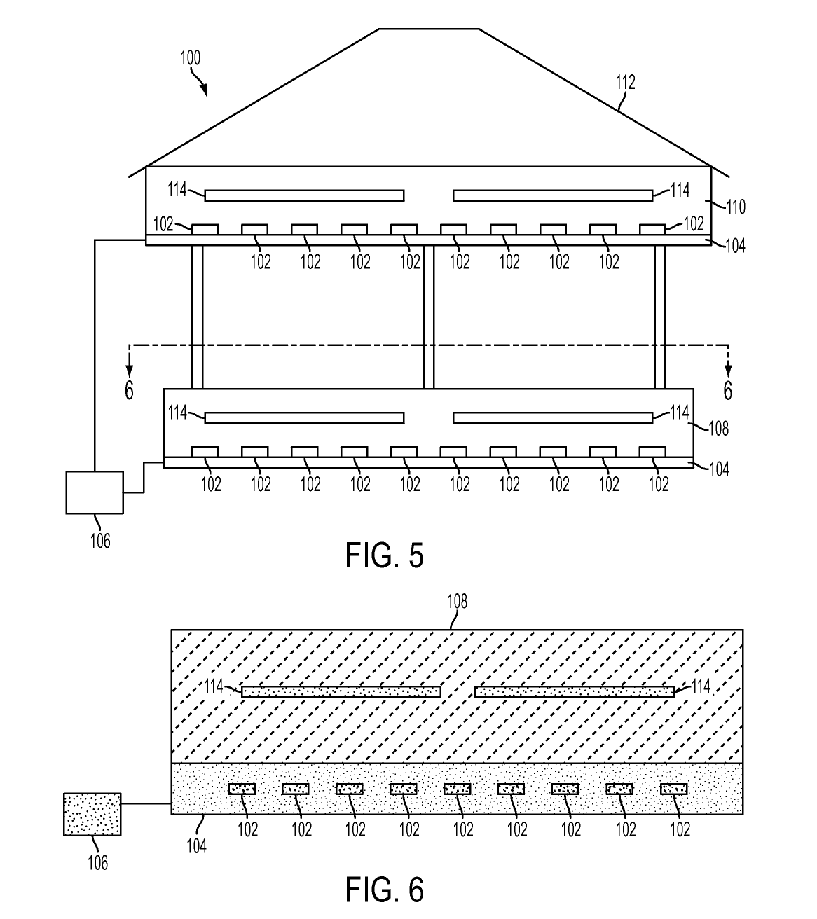

An alternate embodiment is illustrated in FIGS. 4-6 wherein a movable playing structure 100 is formed linearly along a longitudinal axis instead of as a rotating carousel as in the first embodiment of FIGS. 1-3. Playing structure 100 comprises a plurality of tee box areas 102 that are set upon a moving floor 104. Floor 104 can, for example, be an endless belt that is movable via actuation of a motor 106 and appropriate gears and related mechanical assembly. Playing structure 100 further comprises first and second tiers 108, 110, each of which contains the plurality of tee box areas 102, a roof 112 to protect the golfers from inclement weather, service areas 114 for service of food and beverage, as well as other amenities.

As opposed to fairways radiating outwardly from a centrally positioned tee box as in the embodiment of FIGS. 1-3, the embodiment of FIGS. 4-6 includes fairways 116, 118, 120, 122 and 124 (it being understood that the number of fairways can vary depending upon the length and width of the tee box 100 and tee areas 102), that extend linearly outwardly from each tee area (or pair of tee areas) 102. Each fairway 116-124 includes a plurality of greens 126 (three in the illustrated embodiment).

The process of playing the golf game using the embodiment of FIGS. 4-6 is the same as with the embodiment of FIGS. 1-3, except instead of playing structure rotating, the playing structure will move linearly to the next fairway.

The time of the rotating of the playing structure, as well as other automated functions described in detail below, are performed by management system 200. Management system 200 is a computerized system and associated software suite for controlling various automated systems in accordance with various embodiments of the present invention. According to a first embodiment, the computerized system may include a local computer loaded with the software suite. In an alternative embodiment, the computerized system may be a remote server, accessed wirelessly or over the internet. In yet another embodiment, the computerized system may be accessed through a mobile application that could be downloaded onto a mobile device such as a smartphone or tablet. The mobile device may be a user's, such as a player's, mobile device, or a mobile device that is part of management system 200.

The software suite, according to various embodiments includes any combination of a playing structure control subsystem 202, scoring subsystem 204, a ball retrieval subsystem 206, a maintenance subsystem 208, and a food and beverage subsystem 210. According to the preferred embodiment, the software suite will include a graphical user interface (GUI) for accessing and using the various subsystems. A person of ordinary skill in the art will recognize that the term “subsystem” is used generally to refer to a collection of hardware, software, and firmware components. Its use here is merely illustrative, and the software and hardware components may be shared between several subsystems, and any code or hardware used to form a “subsystem” may also be used to form any other “subsystem” or part of any other “subsystem.” For example, while the scoring subsystem is described below as including a system for tracking a golf ball, the tracking system could be associated with management system 200 or any other subsystem without departing from the scope of the present invention.

Management system 200 may further comprise at least one screen for displaying information produced by the various subsystems, such as scores, and maintenance information. Alternatively, management system 200 may comprise multiple displays, located throughout the playing structure. For example, each table, tee, or tier may include its own display. Management system 200 may also comprise an electronic input for receiving commands from a user, such as a mouse, or a remote. In an alternative embodiment, the screens 208 may be touchscreens. In the embodiment wherein management system is accessed via a mobile application, the touchscreen of the mobile device may function as the electronic input. According to the preferred embodiment, management system 200 software suite includes a playing structure control subsystem 202. Playing structure control subsystem 202 controls the timing of the rotation of the playing structure. In a first embodiment, playing structure control subsystem 202 rotates the playing structure at a predetermined time interval. For example, the playing structure may stay in a first position for five minutes, before rotating to a second position. The various time intervals may vary according to different positions. In a second embodiment, the playing structure control subsystem 202 may await a command from a user or employee before rotating. In yet a third embodiment, the tee box control subsystem 202 may monitor, according to sensors located within the tee box, the status of a player or group players and rotate when the monitored players have completed all of their shots.

Scoring is performed by the scoring subsystem 204. According to a first embodiment, the scoring subsystem may access and store a list of players on the management system 200 storage (i.e., local hard drive, remote server, etc.). Scoring may be entered manually by a user. Alternatively, scoring system 204 may automatically score the golfers. Scoring system 204 may include sensors, such as a camera, RFID readers, infrared sensors, or any other systems known in the art sufficient for tracking a golf ball. In the preferred embodiment, a camera may be affixed above each green area and used to track the individual golf balls. In an alternate embodiment, the sensors may be placed at intervals along each green. In yet an alternate embodiment, the sensors may be positioned such that a golf ball may be identified at any location on the green or elsewhere on the course. A lighting system may also be affixed over each green to ensure the green is adequately lit for the use of the camera.

Each golf ball may have a unique identifier which may be read and identified by the scoring system. For example, each golf ball may have at least one uniquely colored stripe. The uniquely colored stripe may be associated with a particular player at the start of the game, or in game. Alternatively, each ball could be marked with a different color, pattern, QR code, bar code, RFID tag, or any other identifier suitable for automatically identifying the location of a ball on a golf course. The unique identifier could be associated with a particular player according to a selection at the start of the game, or during a game. For example, a ball could be assigned to a player management system 200 selector. The identification could take place when the ball is issued to the player, or after the ball is on the course. The selection could be made by viewing a display showing the position of each ball on the course and associating a ball with a player using selector. If any event occurs that could cause the system to lose track of an individual ball, such as a mid-air collision or low-light, the scoring system 200 may query the user to re-associate the correct ball with the correct player, using selector.

Once each ball has been associated with a player, the score may be automatically tallied by scoring subsystem according to the placement of the ball on the course. The score may be displayed on management system 200 displays. Scoring subsystem 204 may also maintain and display broader information, such as league or team scoring information, scorecard selection for each playing, handicaps, bonuses, etc. The score may be displayed according to player, or team, or league. The score may also be displayed on only one display or on multiple displays.

Scoring subsystem 204 may also display tailored information for the course, such as recommended clubs for a particular hole, as well the weather, and wind direction on each hole. Furthermore, scoring subsystem may contain the option to post scores on social networking, such as Facebook, Twitter, Instagram, or any other social networking site. The scoring subsystem may display real-time scores and automatically calculate league standings. Furthermore, the scoring subsystem 204 could maintain a database of prior scores and records, and generate data on player's or teams records over a period of time, such as a season. The data could take the form of a graph or other chart. The data may further be accessible via a remote server and website interface, or mobile application, as is associated with management system 200.

Any number of pre-selectable games may be selected through the scoring subsystem 204. For example, scoring subsystem 204 could track all shots for each player, team and round, award points according to the rules of the particular pre-selected game. For example, the scoring subsystem 204 could award points for the player closest to the hole. Alternatively, scoring subsystem 204 could award points for the farthest drive. Scoring subsystem 204 may also award a prize for a hole-in-one. Furthermore, the scoring system 204 could be programmed to award points for team-based games. A person of ordinary skill in the art will readily recognize that any number of games may be pre-selected and automatically scored according to the placement of the ball on the course. Upon any win, or reached-objective in the game, the displays could be programmed to display and animation or video.

Management System 200 software suit may also include ball retrieval subsystem 206 to control the retrieving of the golf balls on the course. In the preferred embodiment, radio-controlled drones may retrieve any golf balls on the greens. In an alternative embodiment, the balls the may be retrieved by an automated, ground-based robot. In yet an alternative embodiment, a sweeper may be positioned at each green and dragged across the green to sweep all balls into a receptacle where they can be collected and returned. The sweeper may be a rigid bar, a net, a brush, or any other similar appendage suitable for sweeping golf balls into a receptacle. The robots may be directed to retrieve the balls according to their locations as known by management system 200. In an alternative embodiment, the robots may be outfitted with a sensor to identify and retrieve the golf balls automatically.

Management system 200 may also include a maintenance subsystem 208 for tracking information such as equipment usage and lifecycle information to assist in keeping worn equipment from play. Maintenance subsystem 208 may also maintain usage information on any rented equipment and make automatic recommendations for when to replace worn equipment. Maintenance subsystem 208 may also report all scoring, retrieval and system equipment failures immediately to personnel. Furthermore, maintenance subsystem 208 may track capacity information, inventory tracking usage relative to suppliers, players, incentives, and provide real-time information as well as automatically generate periodic summaries of tracked information.

Management system 200 may also contain a food and beverage subsystem 210, for receiving food orders and payment information. Food and beverage subsystem 210 may also contain a system for receiving cash payments, credit card payments, or other electronic payment forms, such as NFC payment systems. Food and beverage subsystem 210 may interface as an order system for food staff, or may interface with an automated food delivery system for delivering pre-prepared food.

A “subsystem” as may be used herein, can include, among other things, the identification of specific functionality represented by specific computer software code of a software program. A software program may contain code representing one or more subsystem, and the code representing a particular module can be represented by consecutive or non-consecutive lines of code.

As will be appreciated by one skilled in the art, aspects of the present invention may be embodied/implemented as a computer system, method or computer program product. The computer program product can have a computer processor or neural network, for example, that carries out the instructions of a computer program. Accordingly, aspects of the present invention may take the form of an entirely hardware embodiment, and entirely firmware embodiment, or an embodiment combining software/firmware and hardware aspects that may all generally be referred to herein as a “system” or “subsystem.” Furthermore, aspects of the present invention may take the form of a computer program product embodied in one or more computer readable medium(s) having computer readable program code embodied thereon.

What is claimed is:

1. A golf game, comprising:
a. a playing structure comprising a plurality of tee box areas each of which is positioned on a playing structure that is movable along a longitudinal axis;
b. a plurality of fairways positioned linearly outwardly from each of said plurality of tee boxes; and
c. a plurality of greens positioned within each of said plurality of fairways, each of said plurality of greens in any one of said fairways being spaced at arbitrary distances from said playing structure than all other of said greens in the same said fairway.

2. (canceled)

3. The golf game of claim 1, wherein said playing structure is mounted on an endless belt that can move along said longitudinal axis.

4. The golf game of claim 1, wherein said playing structure may comprise multiple tiers each of which includes said plurality of tee box areas.

5. The golf game of claim 1, further comprising:
at least one camera positioned to transmit video of one of said fairways;
and a display, positioned to be viewable from within said playing structure, and displaying said camera feed.

6. The golf game of claim 1, further comprising:
a computing device, comprising a non-transitory storage medium, wherein said computing device generates a signal to actuate said playing structure to move upon a predetermined condition.

7. The golf game of claim 6, wherein said predetermined condition is the passage of a predetermined period of time.

8. The golf game of claim 1, further comprising
a computing device, comprising a non-transitory storage medium.
at least one sensor adapted to send a signal representing the location of at least one golf ball, to said computing device;
wherein said computing device is programmed to associate the location of said least one golf ball with at least one user and calculate a score for said user according to the location of the at least one golf ball and a predetermined scoring scheme.

9. The golf game of claim 8, further comprising:
a display, interconnected to said non-transitory storage medium.

10. The golf game of claim 8, wherein said sensors discriminate the location of said golf ball according to an identifier associated with said golf ball.

11. The golf game of claim 10, wherein said identifier is at least one stripe.

12. The golf game of claim 1, further comprising:
an automated ball retriever for collecting golf balls on said greens.

13. The game of claim 12, wherein said automated ball retriever is an elongated arm, attached to a hinge such that said arm may rotate about said hinge, such that said arm may sweep across one said greens and rolling any balls on said green into a receptacle.

14. The game of claim 12, wherein said automated ball retriever is an autonomous, remote controlled device.

15. The golf game of claim 1, further comprising:
a computing device, comprising a non-transitory storage medium; wherein said computing device tracks the usage of at least one piece of equipment; and stores said least one piece of equipment's usage.

16. The golf game of claim 1, further comprising:
a computing device, comprising a non-transitory storage medium.
a payment system, interconnected to said computing device, for receiving electronic payment information from a user.

17. The golf game of claim 1, wherein said playing structure is mounted for movement along a defined path.

18. A method for playing a golf game from a playing structure that is mounted on a rotatable turntable, comprising the steps of:
a. hitting a golf ball from a tee box area towards a first green in a first fairway;
b. indexing said playing structure along a longitudinal axis such that said tee box area faces a second fairway; and
c. hitting a golf ball from said tee box area towards a second green in a second fairway.
